(19) United States
(12) Patent Application Publication
(10) Pub. No.: US 2026/0105802 A1
(43) Pub. Date: Apr. 16, 2026

(54) GAMING TABLE SYSTEM FOR ONLINE LIVE CASINO CARD GAME

(71) Applicant: Evolution Malta Limited, St. Julians (MT)

(72) Inventors: Aleksejs Blinovs, Riga (LV); Vitalijs Petrovs, Riga (LV)

(21) Appl. No.: 19/359,306

(22) Filed: Oct. 15, 2025

(30) Foreign Application Priority Data
Oct. 15, 2024 (EP) 24206708.0

(51) Int. Cl. G07F 17/32

(52) U.S. Cl. CPC G07F 17/322; G07F 17/3293; G07F 17/3276

(57) ABSTRACT

Gaming table systems and associated methods and media for facilitating playing a live casino card game involving betting. An example gaming table system includes a gaming table surface, a player area located on the gaming table surface, a light emitter arranged in proximity to the player area or within the player area, a card dealer area located on the gaming table surface and including a scanning slot, a scanner to identify a physical playing card as it card passes over the scanning slot, a vibrating apparatus to emit a haptic signal, and a computer. In response to receiving a first signal from the scanner indicating that the physical playing card has been identified, the computer is to transmit a second signal that causes the light emitter to emit light and transmit a third signal that causes the vibrating apparatus to emit the haptic signal.

### CROSS-REFERENCE TO RELATED APPLICATIONS

This application is based on and claims priority to European Patent App. No. 24206708.0 filed on October 15, 2024, the entire disclosure of which is incorporated herein by reference.

### TECHNICAL FIELD

The disclosed technology relates to gaming table systems, methods for controlling a gaming table system and thereto related aspects. In particular, but not exclusively, the disclosed technology relates to gaming table systems for providing one or more remote user devices with an online live casino card game.

### BRIEF DESCRIPTION OF THE DRAWINGS

The aspects, features and advantages of the disclosed technology will be more fully appreciated by reference to the following illustrative and non-limiting detailed description of example embodiments of the present disclosure, when taken in conjunction with the accompanying drawings, in which:

FIG. 1 is a schematic illustration of a gaming table system in accordance with some embodiments.

FIG. 2 is a schematic illustration of a gaming table system in accordance with some embodiments.

FIG. 3 is a schematic flowchart representation of a method for operating a gaming table system in accordance with some embodiments.

### DETAILED DESCRIPTION

A player's objective in blackjack is to beat the dealer (in other words, the house) with cards totaling equal to or less than 21, without going over 21, which is known as “busting.” The house has a slight advantage due to the fact that the player must go first and if the player busts, the player automatically loses even if the dealer would have or does subsequently bust.

Before the cards are dealt for each blackjack hand, the player selects the amount he wishes to wager on that hand. The dealer then deals two cards to the player, and two to himself: one face up and one face down. Face cards (kings, queens and jacks) count as 10, aces count as one or 11 (as the player chooses) and all other cards are counted at their face value.

Depending on the pair of cards that are dealt to the dealer and the player, various options are available to the player. If the pair of cards dealt to the player equal 21 (i.e., an ace and a 10 or face card), the player has blackjack and wins the hand unless the dealer also has a blackjack, in which case the hand is a tie, also known as a “push.” A winning blackjack pays the player 3 to 2 on his wager. If the pair of cards dealt to the player do not equal 21, the player may hit or stand, or in certain circumstances, the player may take insurance, split a pair, double down, surrender, or take even money.

The player may “hit” if he wants another card, or “stand” if he is satisfied with the total of his hand and does not want another card. The player may typically hit as many times as he wishes before standing, as long as the player's total does not exceed 21. If any hit causes the player's total to exceed 21, the player busts and automatically loses the hand. If the dealer's face-up card is an ace, the player is given an option to make an insurance wager, which is a side bet that the dealer's face-down (hole) card will be a ten-value card (i.e., either a 10 or a face card). The players can make an insurance bet equal to one half of the player's initial bet on the hand. If the dealer's down card is revealed to be a ten-value card, the player wins the insurance bet at 2 to 1 odds. If the dealer's down card is revealed to be any other card, the player loses the insurance bet.

As more and more content, trade, and even social interaction move into the digital arena many new applications are being developed to enhance the user experience. Furthermore, as we move towards digital solutions trust issues will become of increased importance. If you as a user interact with a software solution there can always be a risk that the software is programmed to deliver content and solutions that are biased in view of the expectations and to the benefit of the content provider.

This is for instance a highly relevant issue relating to areas that depends on some kind of random generator. There is often a risk that these types of solutions will be interpreted as being biased towards the service provider’s benefit. One such technology area can for instance be seen in the gaming industry, such as online casinos providing randomized games such as roulette, card games, crap games, and so on. For this purpose, parts of the online gaming industry combine digital and real-world experience by filming actual casino games with real people as service providers at the casino game tables and providing the user a possibility to interact with real-life games digitally and remotely, a so called online live casino. Thus, the user will be provided with a gaming experience environment as if he or she were present in the casino and with the same randomness as a live casino experience from home or on a mobile user device.

Moreover, with the increased popularity of online live casino games there is an ever-growing need in the art to improve various aspects related thereto, such as for example the human-machine interactions. In particular, when playing fast-paced casino card games such as black-jack, the card dealer may fail to properly scan the card. If this failed scan is unnoticed by the card dealer, the card dealer may nevertheless erroneously deal the card and therefore have to interrupt and restart the game. This may inevitably lead to an impaired user experience and trust issues. Moreover, for the service providers, these interruptions may result in significant financial loss as they generally run hundreds or even thousands of games at any given moment in time.

The herein disclosed technology seeks to mitigate, alleviate or eliminate one or more of the above-identified deficiencies and disadvantages in the prior art to address various problems relating to interruptions in the game caused by an unnoticed failure of a card scan.

Various aspects and embodiments of the disclosed technology are defined below and in the accompanying independent and dependent claims.

A first aspect of the disclosed technology comprises a gaming table system. The gaming table system comprises a scanner configured to identify each physical playing card of a plurality of physical playing cards as they are dealt by a card dealer and a physical gaming table. The physical gaming table comprises a gaming table surface upon which a live casino card game involving betting is playable, a plurality of player areas distributed across the gaming table surface, a plurality of light emitters, each light emitter being arranged in proximity to a respective player area or within a respective player area, and a card dealer area comprising a scanning slot. The scanner is arranged to identify each physical playing card through the scanning slot as each physical playing card is dragged over the scanning slot. The gaming table system further comprises a vibrating apparatus configured to emit a haptic signal to the card dealer, and a computer operatively connected to the scanner, the plurality of light emitters, and the vibrating apparatus. The computer comprises memory and one or more processors operatively coupled to the memory. The one or more processors are configured to, in response to the scanner identifying a physical playing card, cause the computer to transmit a first signal so to cause a light emitter of the plurality of light emitters to emit a light signal and to cause the vibrating apparatus to emit the haptic signal, in order to indicate that the physical playing card has been identified.

A second aspect of the disclosed technology comprises a computer-implemented method for operating a gaming table system comprising a scanner configured to identify physical playing cards, a vibrating apparatus and a physical gaming table having a plurality of light emitters. The method comprises, in response to the scanner identifying a physical playing card, emitting a light signal from a light emitter of the plurality of light to indicate that a physical playing card has been identified, and emitting a haptic signal using the vibrating apparatus in order to indicate that the physical playing card has been identified. With this aspect of the disclosed technology, similar advantages and preferred features are present as in the other aspects.

A third aspect of the disclosed technology comprises a computer program product comprising instructions which, when the program is executed by a computer of a gaming table system, causes the computing device to carry out the method according to any one of the embodiments disclosed herein. With this aspect of the disclosed technology, similar advantages and preferred features are present as in the previously discussed aspects.

A fourth aspect of the disclosed technology comprises a (non-transitory) computer-readable storage medium comprising instructions which, when executed by a computer of a gaming table system, causes the computing device to carry out the method according to any one of the embodiments disclosed herein. With this aspect of the disclosed technology, similar advantages and preferred features are present as in the previously discussed aspects.

The term “non-transitory,” as used herein, is intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link. Thus, the term “non-transitory”, as used herein, is a limitation of the medium itself (i.e., tangible, not a signal) as opposed to a limitation on data storage persistency (e.g., RAM vs. ROM).

The disclosed aspects and preferred embodiments may be suitably combined with each other in any manner apparent to anyone of ordinary skill in the art, such that one or more features or embodiments disclosed in relation to one aspect may also be considered to be disclosed in relation to another aspect or embodiment of another aspect.

An advantage of the technology disclosed herein is that user experience for remote users playing live online casino games may be improved due to a reduced amount of game interruptions and game resets. Another advantage of the technology disclosed herein is that the risk of erroneous dealing of unscanned cards may be reduced. Yet another of the technology disclosed herein is that more perceivable feedback related to successful/unsuccessful card scans may be given to live online casino card dealers, thereby improving their working environment.

Further embodiments are defined in the dependent claims. It should be emphasized that the term “comprises/comprising” when used in this specification is taken to specify the presence of stated features, integers, steps, or components. It does not preclude the presence or addition of one or more other features, integers, steps, components, or groups thereof.

These and other features and advantages of the disclosed technology will in the following be further clarified with reference to the embodiments described hereinafter.

The present disclosure will now be described in detail with reference to the accompanying drawings, in which some example embodiments of the disclosed technology are shown. The disclosed technology may, however, be embodied in other forms and should not be construed as limited to the disclosed example embodiments. The disclosed example embodiments are provided to fully convey the scope of the disclosed technology to the skilled person. Those skilled in the art will appreciate that the steps, services and functions explained herein may be implemented using individual hardware circuitry, using software functioning in conjunction with a programmed microprocessor or general-purpose computer, using one or more Application Specific Integrated Circuits (ASICs), using one or more Field Programmable Gate Arrays (FPGA) and/or using one or more Digital Signal Processors (DSPs).

It will also be appreciated that when some embodiments are described in terms of a method, they may also be embodied in apparatus comprising one or more processors, one or more memories coupled to the one or more processors, where computer code is loaded to implement the method. For example, the one or more memories may store one or more computer programs that causes the apparatus to perform the steps, services and functions disclosed herein when executed by the one or more processors in some embodiments.

It is also to be understood that the terminology used herein is for purpose of describing particular embodiments only and is not intended to be limiting. It should be noted that, as used in the specification and the appended claim, the articles "a", "an", "the", and "said" are intended to mean that there are one or more of the elements unless the context clearly dictates otherwise. Thus, for example, reference to "a unit" or "the unit" may refer to more than one unit in some contexts, and the like. Furthermore, the words "comprising", "including", "containing" do not exclude other elements or steps. It should be emphasized that the term “comprises/comprising” when used in this specification is taken to specify the presence of stated features, integers, steps, or components. It does not preclude the presence or addition of one or more other features, integers, steps, components, or groups thereof. The term “and/or” is to be interpreted as meaning “both” as well and each as an alternative. Similarly, the term “at least one of A and B” refers to both the conjunctive and disjunctive form, meaning only A, only B, or both of A and B.

As used herein, the term “in response to” may be construed to mean “when or “upon” or “if” depending on the context. Similarly, the phrase “if it is determined’ or “when it is determined” or “in an instance of” may be construed to mean “upon determining or “in response to determining” or “upon detecting and identifying occurrence of an event” or “in response to detecting occurrence of an event” depending on the context. Accordingly, the phrase “if X equals Y” may be construed as “when X equals Y”, “when it is determined that X equals Y”, “in response to X being equal to Y”, or “in response to detecting/determining that X equals Y” depending on the context.

It will also be understood that, although the term first, second, etc. may be used herein to describe various elements or features, these elements should not be limited by these terms. These terms are only used to distinguish one element from another. For example, a first signal could be termed a second signal, and, similarly, a second signal could be termed a first signal, without departing from the scope of the embodiments. The first signal and the second signal are both signals, but they are not the same signal.

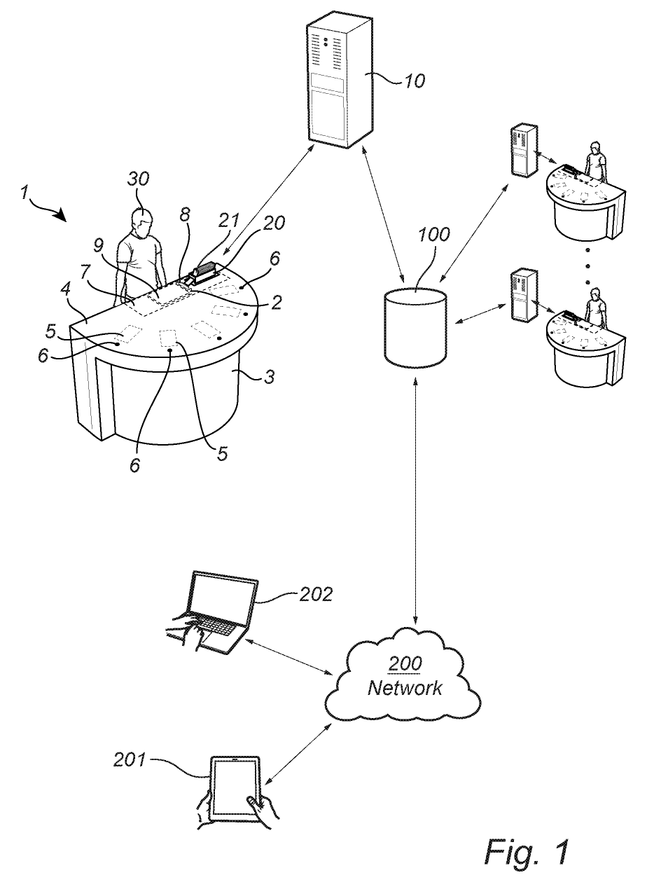

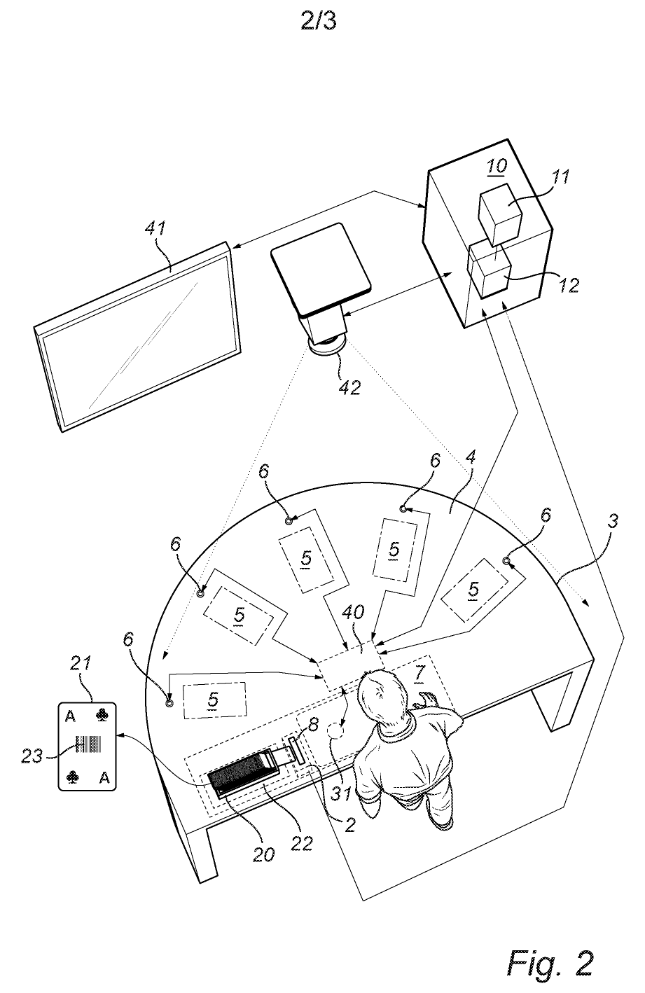

FIG. 1 and FIG. 2 are schematic illustrations of a gaming table system 1 for providing a live casino card game to one or more remote user devices 201, 202 (may also be referred to as user equipment or client devices). The gaming table system 1 is connected to the one or more remote user devices 201, 202 via one or more suitable networks 200 (e.g., internet, local area networks, wide area networks, virtual private networks, mobile data networks, and the like). In more detail, the gaming table system 1 may use a game server 100 to connect remote user devices 201, 202 with the gaming table system 1 so that remote players can participate in the live casino card game. Further, the remote players can connect, via the user equipment 201, 202, to the game server 100 and the gaming table system 1 (more specifically to the computer 10 of the gaming table system 1) to participate in a live casino card game at the physical gaming table 3 and/or other physical gaming tables connected to the game server 100, over the one or more networks 200.

The remote user devices 201, 202 may download run code from the server 100 to provide the live casino card game on the remote user devices 201, 202 (e.g., to provide user interfaces to register user accounts, login to user accounts, to place bet amounts, to make selections in the game, to present a live video stream of the physical gaming table, to present outcomes, to allocate winnings, and so forth). The run code may for example be in the form of an application (“app”) that is downloaded and installed on the user device 201, 202, a browser-based application that runs within a web browser of the user device 201, 202, or any other suitable type of implementation as readily understood by the skilled person in the art. The remote user devices 201, 202 may be any suitable user device having connection capabilities and a user-interface for enabling a user to remotely participate in a live online casino game. Examples of such user devices include smartphones, tablet computers, desktop computers, laptop computers, media computers, virtual reality systems, and augmented reality systems.

The depicted embodiments illustrate a live casino card game in the form of blackjack. However, as readily understood by the skilled artisan, the concepts disclosed herein are analogously applicable to other casino card games such as various poker game variations (Texas Hold’em, five-card draw, etc.).

The gaming table system 1 comprises a scanner 2 configured to identify each physical playing card 21 out of a plurality of physical playing cards 21 as they are dealt by a card dealer 30. The scanner 2 may be implemented in various ways as readily understood by the skilled person in the art. For example, the scanner 2 may be in the form of an optical scanner that is configured to identify each card 21 (suit and number) through optical recognition of one or more unique portions of the physical playing cards 21. In more detail, the scanner 2 may be configured to identify a unique code 23 printed on each card 21, such as for example a barcode 23. The barcode 23 may be in the form of a one-dimensional (1D) barcode (linear barcode) or a two-dimensional (2D) barcode (matrix code). Thus, the scanner 2 may be configured to identify each physical playing card 21 based on a scan of a barcode 23 provided on each physical playing card 21.

However, the scanner 2 may also be an optical scanner that is configured to identify each playing card 21 through image recognition techniques (i.e., computer vision) or radio-frequency-based identification (i.e., detection of RFID tags included in each card 21). Thus, the scanner 2 may be a barcode scanner, a QR code scanner, a camera, an RFID reader, or any other suitable scanner as readily understood by the skilled person in the art.

Moreover, the gaming table system 1 comprises a physical gaming table 3 with a gaming table surface 4 upon which a live casino card game involving betting is playable. The physical gaming table 3 comprises a plurality of player areas 5 distributed across the gaming table surface 4. The physical gaming table has a plurality of light emitters 6 (e.g., Light Emitting Diodes, LEDs), where each light emitter 6 is arranged within or in proximity to a respective player area 5. The player areas may be understood the area in front of a “seat” of a player, i.e., the area where each player’s cards and chips are placed in a conventional blackjack game. A connected remote user device 201, 202 may accordingly be allocated one or more player areas 5 by the game server 100 and/or the computer 10 of the gaming table system 1.

Depending on how one defines a player area, each light emitter 6 may be arranged in proximity to a respective player area 5, or within a respective player area 5. The exact placement of the light emitters 6 is not critical as long as it is clear for the card dealer 30, which light emitter 6 belongs to which player area 5 so that the light emitter 6 can be used to signal various gaming conditions associated with each player area 5 to the card dealer 30. For example, if a light emitter 6 is turned on (i.e., emitting light), this may be used to indicate, to the card dealer 30, that a remote player has been assigned to a specific “seat” and that cards 21 should be dealt to that player area 5. The light emitters 6 may be integrated into the gaming table surface 4.

The physical gaming table 3 further includes a card dealer area 7. The card dealer area 7 refers to an area in front of the card dealer 7, i.e., the area where the deck of cards 21, the dealer’s cards, and the chips may be placed in a conventional blackjack game. The card dealer 7 comprises a scanning slot 8. The scanner 2 is arranged to identify each physical playing card 21 through the scanning slot 8 as each physical playing card is dragged over the scanning slot. In other words, as a card 21 is pulled from a card shoe 20 by the card dealer 30, a portion of the face of the card 21 passes over the scanning 8 slot, enabling the scanner 2 to detect and identify the card 21. The scanning slot 8 is preferably large enough to allow the scanner 2 to get a large enough field of view to scan the card 21 as it passes over the scanning slot 8, but smaller than the card 21 so as not to risk having the falling through the scanning slot 8 as it passes over the scanning slot 8.

Thus, the scanner 2 may be mounted on an underside of the gaming table 3, under the scanning slot such that the optical scanner is facing upwards through the scanning slot 8. However, in case the scanner 2 is implemented using radio-frequency identification techniques, the scanning slot 8 may be omitted, and the scanner 2 may be mounted at a corresponding position on the underside of the gaming table 3 and configured to detect and identify the playing cards 21 through the gaming table as they are dragged on the gaming table surface 4 over the scanner 8. The scanner 2 may be integrated into the gaming table surface 4.

Further, the gaming table system 1 comprises a vibrating apparatus 9 configured to emit a haptic signal to the card dealer 30. In particular, the vibrating apparatus 9 may be configured to provide haptic feedback to the card dealer 30, for example in the form of a vibration that can be sensed by the card dealer 30. In some embodiments, the vibrating apparatus 9 is mounted on an underside of the physical gaming table 3 (i.e., under the gaming table surface 4) below the card dealer area 7. In particular, the vibrating apparatus 9 may be mounted adjacent to the scanning slot 8 or scanner 2 on an underside of the physical gaming table 3. The term “adjacent” to the scanning slot may be understood as that the vibrating apparatus 9 may be mounted within 20 cm, within 10 cm, or within 5 cm from the scanning slot when measuring along the gaming table surface 4.

The vibrating apparatus 9 may be mounted “downstream” of the scanning slot 8 or scanner 2, when considering the pulling of the cards 21 from the card shoe 20 as a flow directed away from the front of the card shoe 20. In other words, the card dealer area 8 may comprise a card shoe area 22 for supporting the card shoe 20 holding the plurality of playing cards 21, and the scanning slot 8 may be arranged between the card shoe area 22 and the vibrating apparatus 9. In other words, the scanning slot 8 may be arranged between the card shoe area 22 and an area of the gaming table surface 4 directly above the vibrating apparatus 9. However, the vibrating apparatus 9 may be arranged at other suitable locations such as for example, on a seat of a chair if the dealer is seated or underneath a standing plate if the dealer is standing. Moreover, in some embodiments, the vibrating apparatus 9 is in the form of a wearable device, such as a bracelet, worn by the card dealer 30.

An advantage of having the vibrating apparatus 9 arranged “downstream” of the scanning slot 8 is that this is the position that the card dealer 30 will “rest” or “hold” his/her hands after pulling and scanning a playing card 21. Thus, the likelihood of perceiving the haptic feedback may be increased as compared to positioning the vibrating apparatus 9 at other positions below the card dealer area 7.

In some embodiments, the vibrating apparatus 9 comprises a vibration motor 31. The vibration motor may be understood as an electromechanical device that receives input electrical power and converts the input electrical power to a mechanical motion in the form of a vibration. The vibration motor may be an eccentric rotating mass motor (ERM), where an off-center weight (eccentric mass) is attached to the motor's shaft. As the motor rotates, the eccentric weight generates vibration due to centrifugal force. However, the vibration motor may alternatively be in the form of a linear resonant actuator (LRA) that uses a spring-mounted mass that moves linearly when driven by an AC signal. In some embodiments, the vibrating apparatus 9 comprises a solid plate and a vibrating motor 31 attached to the plate. The plate, with the motor 31 attached thereto, may be fixed on an underside of the physical gaming table 3, as for example schematically illustrated in FIG. 2. Upon actuation, the vibrations generated by the motor 31 are transferred to at least a portion of the dealer area 7 via the plate. In some embodiments, the motor 31 is arranged in an opening or hole in the plate so that the plate and the motor 31 form an integrated structure in the form of a vibrating plate. Naturally, the size of the plate, the amplitude of the vibrations output by the motor 31, and the thickness of the table top of the physical gaming table 31 are selected so to ensure that an actuation of the vibrating motor 31 adequately transfers into a perceivable vibration at least on the portion of the gaming table surface 4 directly above the vibrating apparatus 9. The plate may for example be made from a suitable rigid plastic material, such as Poly(methyl methacrylate) (PMMA), also known as “acrylic” or “acrylic glass”.

The gaming table system 1 further comprises a computer 10 operatively connected to the scanner 2, the plurality of light emitters 6, and the vibrating apparatus 9. The computer comprises memory 12 and one or more processors operatively coupled to the memory 12. The term “operatively connected” or “operatively coupled” is in the context of the present disclosure to be understood as that the operatively connected/coupled entities or units can transmit and/or receive signals to and/or from each other.

The computer may be connected to a suitable power supply adapted to power the computer and components thereof. The one or more processors are 11 configured to control the operation of the computer 10. The one or more processors may comprise a microprocessor, microcontroller, programmable digital signal processor or another programmable device. The one or more processors 11 (may also be referred to as control circuitry 11) may also, or instead, include an application specific integrated circuit (ASIC), a programmable gate array or programmable array logic, a programmable logic device, or a digital signal processor. Where the one or more processors includes a programmable device such as the microprocessor, microcontroller or programmable digital signal processor mentioned above, the memory 12 include computer executable code that controls operation of the programmable device. Thus, in some embodiments, where the memory 12 contains instructions executable by the one or more processors 11 whereby the computer 10 is operative to execute any one of the method steps or functions disclosed herein.

The one or more processors 11 are configured to, in response to the scanner 2 identifying a physical playing card that is pulled by the card dealer, cause or control the computer 10 to transmit/send one or more signals so to cause a light emitter 6 of the plurality of light emitters to emit a light signal and to cause the vibrating apparatus 9 to emit the haptic signal, in order to indicate, to the card dealer 30, that the physical playing card has been identified. In other words, in response to the scanner 2 transmitting a signal to the computer 10 that is indicative of the scanner having successfully scanned and identified a playing card 21, the gaming table system 1 is arranged to operate one of the light emitters 6 so to emit a light signal and to operate the vibrating apparatus 9 so to emit a haptic signal (e.g., a vibration). The light signal emitted by the light emitter 6 may for example be a blinking light (otherwise referred to as a flashing light).

Furthermore, in response to the scanner 2 not identifying a physical playing card that is pulled by the card dealer 20, the control circuitry 11 may be configured to not actuate the light emitter nor the vibrating apparatus 9, meaning that no light emitter is flashing nor is the vibrating apparatus emitting the haptic signal. Thus, when the card dealer sees the light signal and/or senses the haptic signal, the card dealer 30 will be made aware that the pulled card has been correctly scanned and identified and that the card can be dealt to the player area associated with the light emitter emitting the light signal. However, if no light signal nor haptic signal is perceived, the card dealer 30 is made aware that the pulled card needs to be rescanned.

Thereby, the risk of the dealer erroneously dealing an unscanned playing card 21 to a player may be reduced, and thereby the risk of causing a restart and interruption in the game may be reduced. In particular, only relying on visual feedback may be insufficient for high-pace tasks such as the ones performed by blackjack dealers in an online live casino setting. In particular, for scenarios when a particular dealer is experiencing fatigue or excessive stress, where a visual feedback signal may be inadvertently missed due to a lack of focus or just due to a simple oversight. Having a haptic feedback signal, which may be harder to inadvertently miss, may reduce the number of game interruptions and resets, and thereby reduce the risk of impairing the user experience for the remote players and their trust to the service provider.

Furthermore, in accordance with some embodiments, the one or more processors 11 are configured to, in response to receiving a signal indicative of the scanner 2 having identified a physical playing card from the scanner, store data indicative of the identified physical playing card. Thus, the signal sent from the scanner 2 to the computer 10 may further include information about the scanned card, e.g., suit, number, and a timestamp that is stored in memory 12. The data may also be transmitted from the computer 10 to the server 100 in order to facilitate gameplay and to log the data. The server 100 may for example store the data for traceability and to fulfil various compliance regulations.

The gaming table system 1 may further comprise a lighting controller 40 operatively connected to the computer, to the vibrating apparatus 10, and to the plurality of light emitters 6. Thus, instead of having a direct connection from the computer 10 to the vibrating apparatus 9 and the plurality of light emitters 6, the computer 10 may be indirectly connected to the vibrating apparatus 9 and the plurality of light emitters 6. Thus, the lighting controller 40 may act as a connection hub for the computer 10 to other peripheral components (vibrating apparatus 9 and light emitters 6). Furthermore, the lighting controller 40 may be configured to, in response to receiving the first signal from the computer, transmit a second signal so to cause the light emitter 6 of the plurality of light emitters 6 to emit the light signal, and transmit a third signal so to cause the vibrating apparatus 9 to emit the haptic signal in order to indicate that the physical playing card 21 has been identified. Relaying the signals through the lighting controller may facilitate retrofitting of existing setups as lighting controllers may have suitable inputs and outputs from controlling peripheral components.

Further, in accordance with some embodiments, the gaming table system 1 further comprises a display apparatus 41 operatively connected to the computer. The display apparatus 41 is arranged to face the card dealer 30 so to provide the card dealer with real-time information about the current game. Thus, the one or more processors may be configured to, in response to the scanner 2 identifying the physical playing card, display to the card dealer 30, via the display apparatus 41, a graphical user interface comprising a graphical representation comprising the identified physical playing card. The display apparatus 41 may also be used to convey various other information to the card dealer 30 related to the game play, such as for example, messages from the users of the remote user devices 201, 202, in-game decisions from the user (double, split, hit, hold, draw, etc.), and so forth.

Furthermore, in some embodiments, the gaming table system 1 further comprises a camera 42. The camera may be operatively connected to the computer 10 or to the server 100 via a suitable network connection. The camera 42 may be configured to record a live video stream of at least the gaming table surface 4. The computer 10 and/or the server 100 may accordingly be configured to obtain the live video stream, and to provide this live video stream to one or more remote user devices 201, 202. Thereby, the users of the remote user devices 201, 202 may be provided with a live online casino experience.

During an example use-case in a live game, a remote user may use his/her remote electronic device 201, 202 to connect to a gaming table system 1 via the gaming server 100. Then a live video stream, captured by the camera 42, of at least the gaming table surface 4 may be displayed on a display of the remote electronic device 201, 202. The server 100 and/or the computer 10 of the gaming table system 1 may assign the user to one or more player areas 5 based on a user input conveyed from the remote electronic device 201, 202. The control circuitry 11 of the computer 10 may indicate, to the card dealer 30, that a specific player area 5 has been assigned to a user by activating the associated light emitter 6. Thereby, the card dealer 30 receives a clear indication that the specific player area has been assigned to a user, and that cards may be dealt to that player area in an upcoming round of the live casino card game. Furthermore, the display apparatus 41 may be used to convey further information about or from the user, such as bet amounts, text messages, game play choices (split, double, hit, hold, etc.), and so forth.

The user may be given a limited time period to place bets in order to participate in an upcoming round of the live casino card game, and prompted to select a bet amount via the user interface of the remote electronic device 201, 202. Once a bet has been placed, the round may be started whereupon the card dealer 30 may start to pull playing cards 21 from the card shoe 20. As the card dealer pulls each playing card from the card shoe 20, they will pass, face down, over the scanning slot 8 so that the scanner 2 can scan and identify the pulled card 21. If the scanner 2 successfully scans and identifies the pulled card 21, it sends a signal to the computer 10. The computer 21 may store the data and send another signal to the lighting controller 40 in order to cause the light emitter 6 associated with the relevant user’s player area 5 to emit a light signal, for example in the form of a flashing light.

The lighting controller 40 sends another control signal to the vibrating apparatus 9 so to cause the vibrating apparatus to output a haptic signal. The card dealer 30 is then provided with visual and haptic feedback that the scanner 2 has successfully identified the pulled card and that the card has been registered by the computer 10. The card dealer may therefore deal the card to the player area in order to present the card to the user via the live video stream. The card information (e.g., suit and number) may also be transmitted from the computer 10 to the server 100. The server 100 may then transmit the card information to the remote electronic device 201, 202, causing the remote electronic device 201, 202 to display, via its display, a graphical user interface comprising a graphical representation of one or more virtual graphical elements of the dealt card. Thus, in addition to seeing the dealt card on the live video stream, the user may be further presented with virtual graphical elements of the dealt card on the display of the remote electronic device 201, 202. Naturally, the graphical user interface displayed on the display of the remote electronic device 201, 202 may further display other graphical elements that are overlaid on the live video stream as known in the art, such as e.g., betting chips, aggregated card values, other hands, virtual buttons, and so forth.

Reverting back to the scanning of the pulled card 21, if the scanner 2 would not have identified the pulled card 21, no signal would have been sent from the scanner to the computer 10. Thus, the light emitter 6 associated with the player area 5 would not have flashed, and no haptic signal would have been output from the vibrating apparatus 9. The card dealer 30 would then be made aware that the scan was unsuccessful and could therefore have rescanned the card and waited for the visual and haptic feedback before the card was dealt to the player area 5. It should be noted that instead of sending no signal, the scanner 2 could send a different signal indicating that the scan was unsuccessful to the same effect.

Similarly, instead of no light signal from the light emitter 6 associated with the player area, one could also consider emitting a different light signal as compared to the light signal that is emitted when a pulled card is successfully scanned, such as for example, a flashing light of a different color or a solid light of a different color. Nevertheless, if the card dealer would have missed the indicators of an unsuccessful scan and dealt the playing card 21 without it being identified by the gaming table system 1, the game would have to be interrupted, all bets for that round would have to be void and repaid to the participating users, and the game would have to restart. By having the added haptic feedback, the likelihood that the card dealer 30 perceives the unsuccessful scan of the pulled card may be increased, and therefore the risk of an erroneous deal of the playing card may be reduced, leading to less game-play interruptions and improved user experience.

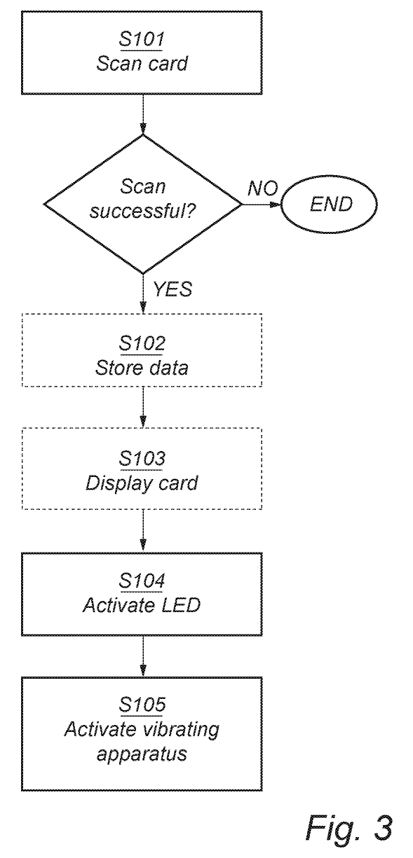

FIG. 3 is a schematic flowchart representation of a method S100 for operating a gaming table system 1 in accordance with some embodiments. In more detail, the gaming table system 1 may be in accordance with any one of the embodiments discussed in the foregoing where the gaming table system 1 comprises a scanner 2 configured to identify physical playing cards 21, a vibrating apparatus 9 and, a physical gaming table 4 having a plurality of light emitters 6. The method S100 is preferably a computer-implemented method S100, performed by a processing system of a computing device. The processing system may for example comprise one or more processors and one or more memories coupled to the one or more processors, wherein the one or more memories store one or more programs that perform the steps, services and functions of the method S100 disclosed herein when executed by the one or more processors.

In some embodiments, the method S100 comprises scanning S101 a physical playing card 21 using the scanner 2. Then, in response to the scanner identifying a physical playing card, the method S100 may comprise storing S102 data, in a computer memory, data indicative of the identified physical playing card. The method S100 may further comprise, displaying S103 to the card dealer, via a display apparatus of the system 1, a graphical user interface comprising a graphical representation comprising the identified physical playing card, in response to the scanner identifying a physical playing card. The term “in response to the scanner 2 identifying a physical playing card” may be understood as “in response to receiving a signal indicating that the scanner 2 has scanned and identified a physical playing card”, “in response to obtaining an indication that the scanner 2 has identified a physical playing card”, or the like.

Further, in response to the scanner 2 identifying a physical playing card, the method S100 comprises emitting S104 a light signal from a light emitter 6 of the plurality of light emitters 6 to indicate that a physical playing card has been identified, and emitting S105 a haptic signal using the vibrating apparatus 9 in order to indicate that the physical playing card has been identified.

The method S100 may further comprise various connection, setup, and authorization steps for securely verifying the connected users and their remote electronic devices 201, 202 as readily understood by the skilled person in the art. However, such peripheral details have been omitted for the sake of brevity and conciseness and to not obscure the present invention.

Executable instructions for performing these functions are, optionally, included in a non-transitory computer-readable storage medium or other computer program product configured for execution by one or more processors.

The present invention has been presented above with reference to specific embodiments. However, other embodiments than the above described are possible and within the scope of the invention. Different method steps than those described above, performing the method by hardware or software, may be provided within the scope of the invention. Thus, according to an exemplary embodiment, there is provided a non-transitory computer-readable storage medium storing one or more programs configured to be executed by one or more processors of a vehicle control system, the one or more programs comprising instructions for performing the method according to any one of the above-discussed embodiments. Alternatively, according to another exemplary embodiment a cloud computing system can be configured to perform any of the methods presented herein. The cloud computing system may comprise distributed cloud computing resources that jointly perform the methods presented herein under control of one or more computer program products.

Generally speaking, a computer-accessible medium may include any tangible or non-transitory storage media or memory media such as electronic, magnetic, or optical media—e.g., disk or CD/DVD-ROM coupled to computer system via bus. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

The processor(s) 11 (associated with the computer 10) may be or include any number of hardware components (e.g., circuitry) for conducting data or signal processing or for executing computer code stored in memory 12. The device 10 has an associated memory 12, and the memory 12 may be one or more devices for storing data and/or computer code for completing or facilitating the various methods described in the present description. The memory may include volatile memory or non-volatile memory. The memory 12 may include database components, object code components, script components, or any other type of information structure for supporting the various activities of the present description. According to an exemplary embodiment, any distributed or local memory device may be utilized with the systems and methods of this description. According to an exemplary embodiment the memory 12 is communicably connected to the one or more processors 11 (e.g., via a circuit or any other wired, wireless, or network connection) and includes computer code for executing one or more processes described herein.

It should be noted that any reference signs do not limit the scope of the claims, that the invention may be at least in part implemented by means of both hardware and software, and that several “means” or “units” may be represented by the same item of hardware.

Although the figures may show a specific order of method steps, the order of the steps may differ from what is depicted. In addition, two or more steps may be performed concurrently or with partial concurrence. For example, the steps of emitting a light signal and emitting a haptic signal may be interchanged based on a specific realization. Such variation will depend on the software and hardware systems chosen and on designer choice. All such variations are within the scope of the invention. Likewise, software implementations could be accomplished with standard programming techniques with rule-based logic and other logic to accomplish the various connecting steps, emitting, storing, scanning, controlling, and displaying steps. The above mentioned and described embodiments are only given as examples and should not be limiting to the present invention. Other solutions, uses, objectives, and functions within the scope of the invention as claimed in the below described patent claims should be apparent for the person skilled in the art.

1. A gaming table system, comprising:
a gaming table surface upon which a live casino card game involving betting is playable;
a player area located on the gaming table surface;
a light emitter arranged in proximity to the player area or within the player area;
a card dealer area located on the gaming table surface, the card dealer area comprising a scanning slot;
a scanner comprising circuitry configured to identify a physical playing card in the live casino game via the scanning slot of the card dealer area;
a vibrating apparatus comprising circuitry configured to emit a haptic signal; and
a computer comprising circuitry configured to:
receive a first signal from the scanner indicating that the physical playing card has been identified;
in response to receiving the first signal from the scanner, transmit a second signal that causes the light emitter to emit light; and
in response to receiving the first signal from the scanner, transmit a third signal that causes the vibrating apparatus to emit the haptic signal.

2. The gaming table system of claim 1, wherein the circuitry of the computer is configured to store data indicative of the physical playing card in memory of the computer in response to receiving the first signal from the scanner.

3. The gaming table system of claim 1, wherein the vibrating apparatus comprises a motor and is located on an underside of the gaming table surface below the card dealer area.

4. The gaming table system of claim 3, wherein the vibrating apparatus is located adjacent to the scanning slot.

5. The gaming table system of claim 4, wherein:
the card dealer area comprises a card shoe area for supporting a card shoe; and
the scanning slot is arranged between the card shoe area and the vibrating apparatus.

6. The gaming table system of claim 1, comprising a lighting controller, the lighting controller comprising circuitry configured to:
receive the second signal from the computer;
send a fourth signal to the light emitter such that the fourth signal causes the light emitter to emit light based on the second signal;
receive the third signal from the computer; and
send a fifth signal to the vibrating apparatus such that the fifth signal causes the vibrating apparatus to emit the haptic signal based on the third signal.

7. The gaming table system of claim 1, wherein the circuitry of the computer is configured to transmit the second signal directly to the light emitter and transmit the third signal directly to the vibrating apparatus.

8. The gaming table system of claim 1, comprising a display apparatus, wherein the circuitry of the computer is configured to cause the display apparatus to display data indicative of the physical playing card in response to receiving the first signal from the scanner.

9. The gaming table system of claim 1, wherein the circuitry of the scanner is configured to identify the physical playing card by scanning a barcode on the physical playing card.

10. The gaming table system of claim 1, wherein the circuitry of the computer is configured to transmit data indicative of the physical playing card to a server in response to receiving the first signal from the scanner.

11. A computer-implemented method for operating a gaming table system that is used to play a live casino card game involving betting, the method comprising:
receiving a first signal from a scanner, the first signal indicating that the scanner has identified a physical playing card associated with the live casino card game;
in response to receiving the first signal from the scanner, causing a light emitter that is located in proximity to or within a player area of the gaming table system to emit light; and
in response to receiving the first signal from the scanner, causing a vibrating apparatus located in proximity to a card dealer area of the gaming table system to emit a haptic signal.

12. The method of claim 11, wherein the vibrating apparatus comprises a motor and is located below the card dealer area on an underside of a gaming table surface of the gaming table system.

13. The method of claim 11, comprising causing a display apparatus to display data indicative of the physical playing card in response to receiving the first signal from the scanner.

14. The method of claim 11, wherein receiving the first signal from the scanner is responsive to the scanner identifying the physical playing card via a barcode on the physical playing card.

15. The method of claim 11, comprising storing data indicative of the physical playing card in memory in response to receiving the first signal from the scanner.

16. A non-transitory computer-readable storage medium comprising instructions that, when executed by processing circuitry, cause the processing circuitry to:
receive a first signal from a scanner, the first signal indicating that the scanner has identified a physical playing card associated with a live casino card game that is played on a gaming table system;
in response to receiving the first signal from the scanner, cause a light emitter that is located in proximity to or within a player area of the gaming table system to emit light; and
in response to receiving the first signal from the scanner, cause a vibrating apparatus located in proximity to a card dealer area of the gaming table system to emit a haptic signal.

17. The non-transitory computer-readable storage medium of claim 16, wherein the vibrating apparatus comprises a motor and is located below the card dealer area on an underside of a gaming table surface of the gaming table system.

18. The non-transitory computer-readable storage medium of claim 16, wherein the instructions, when executed by processing circuitry, cause the processing circuitry to cause a display apparatus of the gaming table system to display data indicative of the physical playing card in response to receiving the first signal from the scanner.

19. The non-transitory computer-readable storage medium of claim 16, wherein the instructions, when executed by processing circuitry, cause the processing circuitry to receive the first signal from the scanner in response to the scanner identifying the physical playing card via a barcode on the physical playing card.

20. The non-transitory computer-readable storage medium of claim 16, wherein the instructions, when executed by processing circuitry, cause the processing circuitry to store data indicative of the physical playing card in memory in response to receiving the first signal from the scanner.
